(19) United States
(12) Patent Application Publication
(10) Pub. No.: US 2014/0215472 A1
(43) Pub. Date: Jul. 31, 2014

(54) TASK MANAGEMENT

(71) Applicant: HEWLETT-PACKARD DEVELOPMENT COMPANY, L.P., Houston, TX (US)

(72) Inventors: Hamid Reza Motahari Nezhad, Los Altos, CA (US); Claudio Bartolini, Palo Alto, CA (US)

(73) Assignee: Hewlett-Packard Development Company, L.P., Houston, TX (US)

(21) Appl. No.: 13/752,932

(22) Filed: Jan. 29, 2013

(51) Int. Cl. G06F 9/46

(52) U.S. Cl. CPC G06F 9/46
USPC 718/102

(57) ABSTRACT

An example of task management can include receiving a message between a sending user and a receiving user. The message can be analyzed to determine whether the message includes a requested task. A parameter of the requested task can be extracted from the message based on directives in the message. An update to a status of the task can be sent to the sending user and the receiving user.

### BACKGROUND

A sales division of a business may form teams of people to generate customer leads, pursue those leads, and close deals with the customer. A sales person may be responsible for manual input of these interactions into a system. The same data may need to be entered more than once resulting in unnecessary duplication of work. This can cause inconsistencies in the data. In addition, updating such a system may be cumbersome and time-consuming and may sometimes be overlooked.

### BRIEF DESCRIPTION OF THE DRAWINGS

FIG. 1 illustrates a block diagram of an example of a system for task management according to the present disclosure.

FIG. 2 illustrates a block diagram of an example of a method for task management according to the present disclosure.

FIG. 3 illustrates a block diagram of an example of processing resources and memory resources for task management according to the present disclosure.

### DETAILED DESCRIPTION

A business can have a group of employees (e.g., sales people) to help sell a product of the business. A business can have a group of sales people to monitor and/or participate in information technology (IT) outsourcing deals. IT outsourcing deals can be complex and may need resources to monitor the deals. A management team overseeing the sales people can request a report from the sales people regarding leads to potential customers, the status of those leads, and whether a deal with a customer has been closed (e.g., finalized, agreed upon signed, etc.). An action related to the deal can be monitored by designating the action an action item or a task.

An action item and/or a task can be an action taken by a person involved with the deal. For example, a task can include a sales person contacting a potential customer, discussing prices and/or possible resource allocation with a customer, closing a deal with a customer, among other actions. The task can also include a safes person communicating with another sales person about actions taken in relation to the deal. For example, a task can include a sales person reviewing a proposal to a customer, discussing a deal proposal with another sales person, negotiating with other people within the business of the sales person to later relay to the customer, among other actions. Keeping track of concurrent action items can assist in monitoring multiple tasks contributing to the deal at the same time. Distinguishing between different types of tasks and various priorities can assist in carrying out the tasks.

A conduit for assigning a business task to a business person can be through email. A conduit for sending an update regarding the business task from one business person to another also can be through electronic mail (i.e., email). A task update at the workflow application can occur after the task update has been exchanged between employees. For example, a first business person can send a second business person an email designating an update to a task (e.g., that a task has been performed). The first business person can then manually enter the update into a workflow application subsequent to sending an email confirmation to the second business person.

A business person can interact with a workflow application in order to update a status of a business task (e.g., a customer may have been pursued, a customer may have bought a product, etc.). A business person can manually enter the status of the business task into the workflow application. Automatically linking information in an email to a workflow application can allow the application to update a task more quickly, efficiently, reliably, etc. The linking of task information in an email to a workflow application can use a language to structure email information to enable extraction of useful keywords.

Information that is structured in such an email can be used to identify particular parameters of the information. Information that may not be structured can be used to identify particular parameters along with structured information in order to make the non-structured information helpful in identifying tasks (e.g., contact a customer, contact a business person, close a deal, etc.) and parameters of tasks (e.g., task identification, status of a task, responsibility for a task, etc.).

Embodiments of the present disclosure can include multiple network devices, systems, including executable instructions and/or logic thereon, and methods for task management. A network device can include a processing resource(s) and/or logic coupled to a memory. The memory can include program instructions executable by the processing resource(s) to monitor a task. An example of a computer-implemented method for task management can include receiving, via communication links, a message between a sending user and a receiving user at a task management database, determining whether the message includes a requested task, extracting a parameter of the requested task based on directives in the message, and updating a status of the requested task.

In the following detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the embodiments of this disclosure, and it is to be understood that other examples may be utilized and that process, electrical, and/or structural changes may be made without departing from the scope of the present disclosure.

As used herein, “a number of” an element and/or feature can refer to one or more of such elements and/or features. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

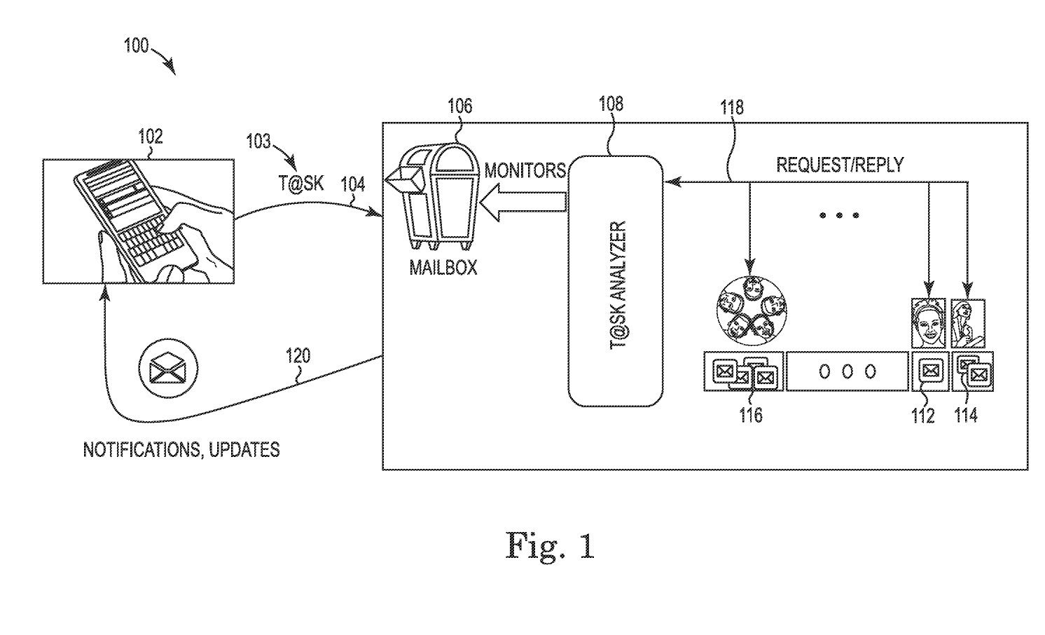

FIG. 1 illustrates a block diagram of an example of a system for task management according to the present disclosure. As illustrated in the example of the system 100 shown in FIG. 1, a user 102 (e.g., a business person, a sales person, an employee, etc.) can use a computing device (e.g., a mobile device, a cell phone, a smart phone, a laptop, etc.) to send, via a communication link 104, a message (e.g., an email, an SMS or short text message, etc.) to a database 106 (e.g., a task management database, a mailbox, an e-mail box, etc.). For example, a sales person (e.g., the user 102) can send (e.g., via communication link 104) an email to the database (e.g., mailbox 106) which may also have been sent to another user as well. A mailbox database may be a privately shared mailbox. For example, only particular users would be able to access the mailbox.

Communication links, as used herein, can include network connections, such as logical and/or physical connections. In some examples of the present disclosure, the communication links (e.g., 104) can provide communication from the user 102 to the database 106 and may also be communication links (e.g., 120) providing communication from the database 106 to the user 102. In some examples of the present disclosure, there can be two separate sets of communication links, one for communication from the user 102 to the database 106 (e.g., 104) and another for communication from the database 106 to the user 102 (e.g., 120).

A processor 108 (e.g., a T@sk Analyzer) can monitor the database 106 (e.g., a task management database, the mailbox, etc.). The monitoring can be performed using a monitoring link (e.g., communication link, network link, etc.). The processor 108 can also be in the same computing device as the database 106 and may not need a monitoring link. The processor 108 can thereby monitor the database 106 for an incoming message 103 (e.g., a T@sk). The processor 108 can begin processing the message 103 when received (e.g., immediately, intermittently, periodically, etc.). The processor 108 can begin processing the message 103 in a particular sequence based on, for example, a deadline in the message and/or importance of the task described in the message. The processor 108 can begin processing a message 103 based on a priority (e.g., receipt order) of the incoming message 103.

The processor 108 (e.g., the T@sk Analyzer) can use a language protocol in order to analyze the message 103 saved in the database 106. The language protocol can include task parameters that guide analysis of the message 103. The task parameters can be identified by locating language directives and/or word patterns. For example, a language protocol can identify a particular word or words that indicate a corresponding task parameter.

A language protocol can include keywords such as, for example, “request,” “agree,” “report,” and “accept,” etc. Such keywords can be mapped to particular task identifications. For example, an email including the keyword “request” can designate an assignment of a task. An email including the keyword “agree” can designate an acceptance and/or delegation of a task. An email including the keyword “report” can designate a completion of a task. An email including the keyword “accept” can designate approval, acceptance, and/or revision of a task.

A task parameter can include a name, a case identification (id), a due date, an assignment, an acceptance of an assignment, a status, a priority, a delegation of a task, a designation that the task is archived, etc. A case can include a number of tasks. For example, a case can include all negotiations with a specific client. The case may include several tasks related to the client such as discussing the product with the client, determining what the client is willing to pay, etc.

By way of example and not by way of limitation, the language protocol can include task parameters in the following format:

$TASK ‘name’ in [case_id]

DUE date
ASSIGN/ACCEPT [@email] AS [A|R|C|I]
STATUS [Open|Assigned|Completed]
Priority [Low|Medium|High]
Delegate [@email]
Archive

A designator in the ASSIGN/ACCEPT line including any of AIRICII can include accountable, responsible, consulted, and informed, respectively, to designate a role of a user. For example, a user can be assigned a designation as accountable and would be designated as accountable by “[A]” after the “ASSIGN” designator and “[@email]” designator. Each of these roles will be described in more detail below. A priority status can be designated in the same way as low, medium, or high. For example, a low priority task can include [Low].

To give an example of these designations, a task that is named Customer Yellow, can have a case identification of 12345, can be due on Jan. 1, 2013, can be assigned to a user with email john.doe@jd.com who had initially accepted the task, can have medium priority, and can be subsequently delegated from John Doe to Jane Doe. Accordingly, such an example task can have the following parameter format in a sent message:

$TASK ‘Customer Yellow’ in [case_12345]

DUE 1/1/2013
ASSIGN [john.doe@jd.com] AS [A]
STATUS [Assigned]
Priority [Medium]
Delegate [jane.doe@jd.com]

A message can include at least one task parameter or any number of task parameters.

A message can be sent to report progress or provide a status update with, for example, the following task parameter format:

REPORT [task_name] in [case_id]

[Short|Complete]
[with|No Attachment]

A message may include a report for a given task by including a task name in [task_name]. For example, a message can be sent to a database 106 (e.g., a mailbox, an e-mail box) with a task parameter format including REPORT [task_name] in [case_id] and update the task designated in [task_name] by including [Complete] to designate the task has been completed. The database 106 can then update the task status with the received information.

A message can request a report of a latest status of a task and/or a whole case including multiple tasks. To request the report of the status of the task, a message can include a particular subject line. For example, a request to receive a report of a status of a task can include “$Task ‘name’ status” in the subject line. In addition, to receive a report of a case,' a different designation can be made in the message. For example, an asterisk can be used in place of [task_name] to indicate a request for a report for an entire case of tasks.

The processor 108 (e.g., the T@sk Analyzer) can designate a first user (e.g., user 102) sending a message as being responsible for a task. The processor 108 can designate a second user (e.g., user 112) as being accountable for the task. The second user may be designated as accountable when the second user accepts accountability for the task. The processor 108 can send a message including a task to multiple users (e.g., a plurality of users at 114) and/or a pool of users (e.g., pool of users 116). The processor 108 can send a message via communication links 118. The communication links can comprise a direct cable, a wired network, a wireless network, a mobile carrier device, etc.

The system of FIG. 1 can include a graphical user interface (GUI) to allow a user (e.g., user 102) to input information. The GUI can allow the user to verify, modify and/or add information relating to tasks.

A receiving user 112, receiving users 114, and/or a pool of users 116 can send a number of replies to the processor 108 indicating an update to the task. A receiving user 112, receiving users 114, and/or a pool of users 116 can send a request for a report, a status update, etc., to the processor 108. The processor 108 can send a task update and/or notification to a sending user 102 via a communication link 120. For example, a processor can send a user a message to notify the user that a task needs to be completed by the end of the week. The processor 108 can send an update and/or notification to any of a receiving user 112, receiving users 114, or a pool of users 116.

The processor 108 can interface with a workflow application. A workflow application can be a software application that automates a process or processes. The process may be a process that requires a series of steps that can be automated via software. Some steps may include manual approval or interaction to change and/or update the application. The workflow application can be a backend workflow application (i.e., a workflow application on the backend).

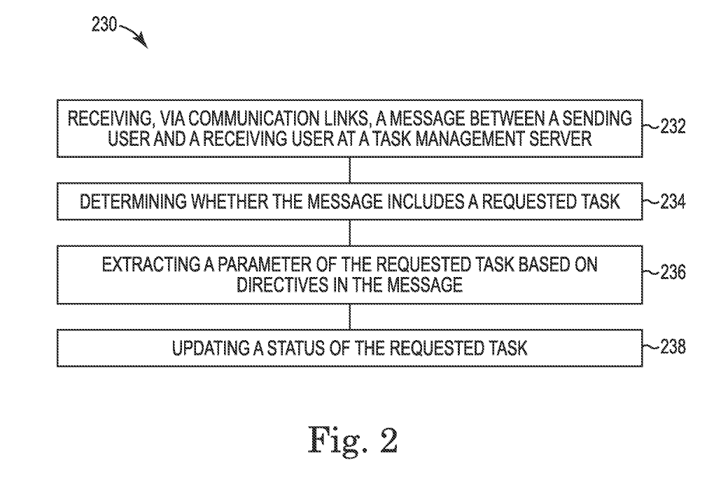

FIG. 2 illustrates a block diagram of an example of a method of task management according to the present disclosure. The example of the method 230 can include, as shown at block 232, receiving, via communication links, a message between a sending user and a receiving user at a database (e.g., a task management database, a mailbox as in 106 in FIG. 1, etc.). A user (e.g., as shown at 102 in FIG. 1) can use a computing device (e.g., a mobile device, a cell phone, a smart phone, a laptop, etc.) to send, via communication links (e.g., as shown at 104 in FIG. 1), a message (e.g., an email, a text, etc. as shown at 103 in FIG. 1) to a database (e.g., a task management database, an e-mailbox, etc. as shown at 106 in FIG. 1). For example, a sales person can send (e.g., via communication link 104) an email to the mailbox (e.g., 106), which may have also been sent to another user as well.

As shown at block 234, the method 230 can include determining whether the message includes a requested task. A processor (e.g., T@sk Analyzer as shown at 108 in FIG. 1) can connect to the database (e.g., a task management database, a mailbox as shown at 106 in FIG. 1). The processor can use a language protocol in order to analyze the message. The message can include task parameters that can be identified by locating language directives and/or word patterns within the message.

For example, a language protocol can identify a particular word or words that indicate a corresponding task parameter. A task parameter can include a name, a case identification (id), a due date, an assignment, an acceptance of an assignment, a status, a priority, a delegation of a task, a designation that the task is archived, etc.

As shown at block 236, the method 230 can include extracting a parameter of the requested task based on directives in the message. A parameter of the requested task can include task identification, a status of a task, responsibility for a task, a task deadline, among others. For example, a message can include a directive (e.g., a word in a subject line, a language directive, a keyword, a particular format, etc.) that indicates that a task has been completed. In another example, a message can include a directive that the task has a deadline of due in one week.

An extracted parameter can include a designation that the sending user is accountable and the receiving user is responsible for the task (e.g., for monitoring the task, for managing the task, for verifying the task's completion, etc.). For example, a first user can send a message that includes a request to perform a task to a second user. The first user can be designated as accountable for the task while the second user can be designated as responsible (e.g., for delegating the task, completing the task, etc.). If the second user delegates the task to a third user, the second user can be designated as accountable and the third user as responsible.

In some examples, a message including a task request can be sent from a first user to a plurality of receiving users (e.g., as shown at 114 in FIG. 1). The receiving users can be designated as a pool of users (e.g., as shown at 116 in FIG. 1). When the message is sent to a plurality of receiving users and/or a pool of users, the responsible users can be designated as open until at least one user replies with an acknowledgement that the user will perform the task. The replying user can then be designated as responsible. The users not designated as responsible for the task from the pool of users can be designated as notified concerning the requested task. For example, a first user and a second user can receive a message including a task. The first user can acknowledge the first user will perform the task. The second user can then be designated as notified about the task but not accountable for the task.

As shown at block 238, the method 230 can include updating a status of the requested task. A sending and/or a receiving user can send a reply to the processor indicating an update to a task. A sending and/or receiving user can send a request for a report, a status update, etc., to a processor. The processor can send a task update and/or task notification to a receiving and/or sending user that requested the task update and/or the notification. For example, a first user can request an update to a task that the first user requested a second user to perform. The processor can send a task update to the first user indicating that the second user performed the task. A user can request a particular date to receive an update and/or notification and/or reminder.

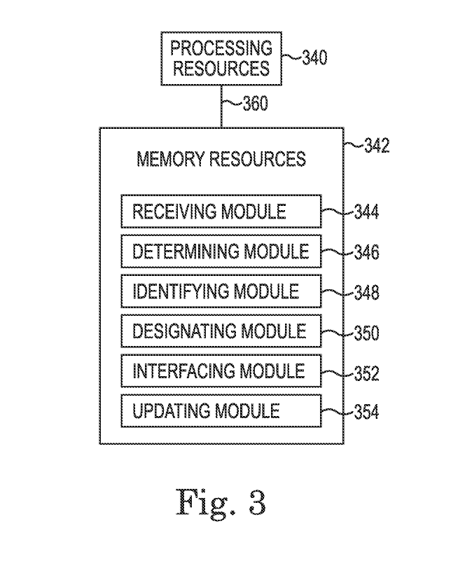

FIG. 3 illustrates a block diagram of an example of processing resources and memory resources for task management according to the present disclosure. The processing resources 340 and the memory resources 342 illustrated in FIG. 3 can be local to a computing network, such as on a router. The memory resources 342 (e.g., a tangible, non-transitory machine-readable medium) can store a set of machine-readable instructions (e.g., software, firmware, etc.) executable by the processing resources 340. Memory resources 342 may be integrated in a single device or distributed across multiple devices. The memory resources 342 may be fully or partially integrated in the same device as processing resources 340 or may be separate but accessible to that device and the processing resources 340 (e.g., via a communication path 360). The memory resources 342 can be local to a router or remote therefrom. For those examples in which the memory resources 342 is remote from the router, the instructions can be loaded into the memory resources of the router.

Memory resources 342 can be in communication with a number of processing resources of more or fewer than 340. The processing resources 340 can be in communication with tangible non-transitory memory resources 342 storing a set of machine-readable instructions (MRI) executable by one or more of the processing resources 340, as described herein. The MRI can be stored in a number of modules 344, 346, 348, 350, 352, and 354. The MRI can also be stored in remote memory and represent an installation package that can be downloaded, installed, and executed.

Processing resources 340 can execute MRI that can be stored on internal or external non-transitory memory resources 342. The processing resources 340 can execute MRI to perform various functions, including the functions described in FIG. 1 and FIG. 2. For example, the processing resources 340 can execute MRI to implement managing a task described with regard to FIGS. 1 and 2.

The number of modules 344, 346, 348, 350, 352, and 354 can include MRI that, when executed by the processing resources 340, can perform a number of functions. A receiving module 344 can include MRI that when executed by the processing resources 340 can receive a message from a sending user, which may also be sent to a receiving user. The receiving module 344 can receive a message from a mailbox (e.g., as shown at 106 in FIG. 1). The receiving module can monitor the mailbox and extract the message to be analyzed.

A determining module 346 can include MRI that when executed by the processing resources 340 can determine whether a message contains a requested task. A processor (e.g., T@sk Analyzer as shown at 108 in FIG. 1) can connect to a database (e.g., 106 in FIG. 1). The processor can use a language protocol in order to analyze a message. The message can include task parameters that can be identified by locating language directives and/or word patterns within the message. For example, a language protocol can identify a particular word or words that indicate a corresponding task parameter.

An identifying module 348 can include MRI that when executed by the processing resources 340 can identify a task parameter within a message by locating language directives and/or word patterns. The processor (e.g., T@sk Analyzer as shown at 108 in FIG. 1) can use a language protocol in order to analyze the message. The language protocol can include task parameters that guide analysis of the message. The task parameters can be identified by locating language directives and/or word patterns. For example, a language protocol can identify a particular word or words that indicate a corresponding task parameter.

A designating module 350 can include MRI that when executed by the processing resources 340 can designate a user sending a message as accountable for a task and a receiving user as responsible. A plurality of receiving users can be placed in a pool of users that is considered open. A designation of accountable for a task can be designated when a user in the pool of users takes responsibility for the task. A receiving user and/or a sending user can forward a message with a requested task to another user. The other user can be designated as consulted when the other user receives the message.

An interfacing module 352 can include MRI that when executed by the processing resources 340 can interface with a backend workflow application to transmit parameter information related to a requested task included in a message. For example, a first user can send a message with a requested task to a second user along with an email to a mailbox. The first user can be designated as accountable and the second user as responsible. A processor can access the privately shared mailbox and extract parameter information. The processor can send parameter information to the backend workflow application. The backend workflow application can now designate the first user as accountable for the task and the second user as responsible for the task.

An updating module 354 can include MRI that when executed by the processing resources 340 can update parameter information related to a requested task. An update can occur when a subsequent message is received from a user designating a change in a parameter of a task. An update can be sent to a backend workflow application. An update can be sent to a user that has sent a message with a request to the processor to receive an update on a task and/or on an entire case of tasks. For example, a case can include negotiating with a client for a sale, determining what the client is willing to pay, etc. A user can send a message that the user wants to be updated about whether any user has determined what the client is willing to pay. The user can send a message to be updated about whether any user has completed any or all of the tasks of the case.

The number of modules 344, 346, 348, 350, 352, and 354 can be sub-modules of other modules. For example, a receiving module 344 and a determining module 346 can be sub-modules and/or contained within the receiving module 344 in FIG. 3. In another example, the number of modules 344, 346, 348, 350, 352, and 354 can comprise individual modules on separate and distinct computing devices.

Non-transitory memory resources 342, as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, as well as other types of computer-readable media.

The non-transitory memory resources 342 can be integral, or communicatively coupled, to a computing device, in a wired and/or a wireless manner. For example, the non-transitory memory resources 342 can be an internal memory, a portable memory, a portable disk, or a memory associated with another computing resource (e.g., enabling MRIs to be transferred and/or executed across a network).

The memory resources 342 can be in communication with the processing resources 340 via the communication path 360. The communication path 360 can be local or remote to a machine (e.g., a computer) associated with the processing resources 340. Examples of a local communication path 360 can include an electronic bus internal to a machine (e.g., a computer) where the memory resources 342 are volatile, non-volatile, fixed, and/or removable storage medium in communication with the processing resources 340 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 360 can be such that the memory resources 342 are remote from the processing resources 340, such as in a network connection between the memory resources 342 and the processing resources 340. That is, the communication path 360 can be a network connection. Examples of such a network connection can include a local area network (LAN), wide area network (WAN), personal area network (PAN), and the Internet, among others. In such examples, the memory resources 342 can be associated with a first computing device and the processing resources 340 can be associated with a second computing device (e.g., a Java server). For example, the processing resources 340 can be in communication with the memory resources 342, where the memory resources 342 include a set of instructions and where the processing resources 340 are designed to carry out the set of instructions.

The processing resources 340 coupled to the memory resources 342 can execute MRI to receive a message from a sending user to a receiving user at a task management database. The processing resources 340 coupled to the memory resources 342 can also execute MRI to determine whether the message includes a requested task. The processing resources 340 coupled to the memory resources 342 can also execute MRI to identify task parameters within the message by locating language directives and word patterns. The processing resources 340 coupled to the memory resources 342 can also execute MRI to designate the sending user as accountable and the receiving user as responsible. The processing resources 340 coupled to the memory resources 342 can also execute MRI to interface with a backend workflow application to transmit parameter information related to the requested task included in the message. The processing resources 340 coupled to the memory resources 342 can also execute MRI to update the parameter information of the requested task as updating information in subsequent messages is received from a user.

As used herein, “logic” is an alternative or additional processing resources to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processor. The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A computer-implemented method for task management, comprising:
receiving, via communication links, a message between a sending user and a receiving user at a task management database;
determining whether the message includes a requested task;
extracting a parameter of the requested task based on directives in the message; and
updating a status of the requested task.

2. The method of claim 1, comprising designating the sending user as accountable and the receiving user as responsible.

3. The method of claim 2, comprising designating a plurality of receiving users as a pool of receiving users and designating the pool as open until a receiving user confirms that the user is responsible for performing the task.

4. The method of claim 2, comprising designating a receiving user in the pool as responsible for the requested task when a message is received from the receiving user in the pool including a notification that the receiving user is responsible for performing the requested task.

5. The method of claim 2, comprising designating any receiving users in the pool as notified concerning the requested task when a message is received from a different user in the pool including notification that the different user is responsible for performing the requested task.

6. A computing system for task management, comprising:
a memory resource; and
a processing resource coupled to the memory resource to:
receive, via communication links, a message from a sending user to a receiving user comprising a request to complete a task;
identify task parameters within the message by locating language directives and word patterns;
interface with a backend workflow application to transmit parameter information related to the requested task in the message; and
update the parameter information of the requested task.

7. The system of claim 6, wherein the task parameters comprise at least one of a task name, a due date, and a status.

8. The system of claim 6, comprising the processing resource coupled to the memory resource to receive a request message from either of a sending user and a receiving user that includes a keyword designating a request.

9. The system of claim 8, comprising the processing resource coupled to the memory resource to send a report of a corresponding task to the requesting user when the keyword in the request message designates a task and to send a report of a corresponding case to the requesting user when the keyword in the request message designates a case.

10. The system of claim 6, wherein a document attached to the message is associated with the task in the backend workflow application.

11. A non-transitory machine-readable medium storing a set of instructions for task management that, when executed by a processing resource, causes a computer to:
receive, via communication links, a message from a sending user to a receiving user at task management database;
determine whether the message includes a requested task; and
for a message that includes the requested task:
identify task parameters within the message by locating language directives and word patterns;
designate the sending user as accountable and the receiving user as responsible;
interface with a backend workflow application to transmit parameter information related to the requested task included in the message; and
update the parameter information of the requested task as updating information in subsequent messages received from a user.

12. The medium of claim 11, comprising instructions to receive a request from a user about a status of the requested task and send a message with the status of the requested task.

13. The medium of claim 11, comprising instructions to designate a user as consulted when the user has received a forwarded message from either of the sending user and the receiving user including the requested task.

14. The medium of claim 11, comprising instructions to send a reminder message to a responsible user about task deadlines and the updated parameter information.

15. The medium of claim 11, comprising instructions to receive a message from a user signifying the requested task is complete and designate the requested task as complete in the backend workflow application.
